(19) United States
(12) Patent Application Publication
(10) Pub. No.: US 2017/0210111 A1
(43) Pub. Date: Jul. 27, 2017

(54) METHOD AND APPARATUS FOR ROOM TEMPERATURE BONDING SUBSTRATES

(71) Applicant: PYCOSYS INCORPORATED, Santa Barbara, CA (US)

(72) Inventors: Raymond M. Karam, Santa Barbara, CA (US); Rocco Lafleur, Santa Barbara, CA (US); Rob Hobden, Santa Barbara, CA (US)

(21) Appl. No.: 15/418,440

(22) Filed: Jan. 27, 2017

Related U.S. Application Data
(60) Provisional application No. 62/287,884, filed on Jan. 27, 2016.

(51) Int. Cl. B32B 38/00; B32B 7/14; E06B 3/673; B32B 37/12; B32B 37/00; E06B 3/66; B32B 7/04; B32B 37/06

(52) U.S. Cl. CPC B32B 38/0008; B32B 7/045; B32B 7/14; B32B 37/065; B32B 37/1207; B32B 37/1292; B32B 37/0053; E06B 3/6612; E06B 3/67334; B32B 2310/0843; B32B 2310/14; B32B 2419/00

(57) ABSTRACT

A particle micro/nanoparticle filled paste is employed to create an absorbing/sintering interlayer for a bonding process which avoids the need to grind/polish large substrates and eliminates the need for more expensive sputtering process.

### REFERENCE TO RELATED APPLICATIONS

This application claims the priority of U.S. provisional application Ser. No. 62/287,884 filed on Jan. 27, 2016 entitled METHOD AND APPARATUS FOR ROOM TEMPERATURE BONDING SUBSTRATES. This application is copending with U.S. applications Ser. No. 15/275,187 filed on Sep. 23, 2016 entitled ROOM TEMPERATURE. GLASS-TO-PLASTIC AND GLASS-TO-CERAMIC/SEMICONDUCTOR BONDING which is a divisional application of Ser. No. 13/291,956 now U.S. Pat. No. 9,492,990, Ser. No. 13/769,375 filed on Feb. 17, 2013 entitled ATTACHMENT OF A CAP TO A SUBSTRATE-BASED DEVICE WITH IN SITU MONITORING OF BOND QUALITY, Ser. No. 14/270,265 filed on May 5, 2014 entitled METHODS TO FORM AND TO DISMANTAL HERMETICALLY SEALED CHAMBERS and Ser. No. 14/976,475 filed on Dec. 21, 2015 entitled KINETICALLY LIMITED NANO-SCALE DIFFUSION BOND STRUCTURES AND METHODS, all having a common assignee or common inventor with the present application, the disclosures of which are incorporated herein by reference.

### BACKGROUND INFORMATION

Field

Embodiments of the disclosure relate generally to the field of large format substrates and more particularly to a methods and structures bonding of glass windows for vacuum insulated glazing (VIG) using micro/nano particles deposited and sintered with room temperature laser bonding.

Background

Joining of large format substrates, particularly glass, is necessary for various environmental, visual or structural reasons. However, creating an appropriate bond between the substrates typically requires a very flat surface on both substrates. Prior art systems typically employ sputtering of traces or bond-lines on the substrates using various materials, mating the substrates and oven sintering the sputtered trace to join the substrates. This process requires very large sputtering chambers and or curing ovens.

It is therefore desirable to provide an apparatus and method for creating an absorbing/sintering interlayer for a bonding process which avoids the need to grind/polish large substrates and eliminates the need for more expensive sputtering process. This is especially true for larger format substrates that may not fit in typical sputtering chambers, are not flat enough for precision processing, i.e., tempered glass.

It is also desirable to provide a bonding machine using a roller or air knife force application or which indexes the work piece under a smaller optical flat to allow bonding of much larger substrates than otherwise possible.

### SUMMARY

Embodiments disclosed herein provide methods and apparatus for use of a micro/nano-particle filled paste to create an absorbing/sintering interlayer for a bonding process which avoids the need to grind/polish large substrates and eliminates the need for more expensive sputtering process. This is especially applicable for larger format substrates that may not fit in typical sputtering chambers or are not flat enough to otherwise perform room temperature bonding (RTB), particularly tempered glass. One example application that would benefit from these embodiments is the manufacture of Vacuum insulating Glazing (VIG).

Applying metal filled paste via ink jetting, syringe dispense, spin coating or brush/spatula/doctor blade applications is much easier and less expensive than sputtering and room temperature bonding is more effective than laser sintering, flame sintering or oven sintering of the nano-particles.

Additionally, the embodiments provide for using micro/nanoparticle filed paste to bond two substrates using an RTB process.

A bonding machine using a roller or air knife force application or by indexing the work piece under a smaller optical flat allows bonding of much larger substrates than otherwise possible. This is more tolerant to flatness deviations over large areas since a localized pressure can insure intimate contact at location being bonded.

The embodiments disclosed allow applying the laser beam from both sides to both sinter the material and RTB the glazing/glass plates at the same time.

The features, functions, and advantages that have been discussed can be achieved independently in various embodiments of the present disclosure or may be combined in yet other embodiments further details of which can be seen with reference to the following description and drawings.

### BRIEF DESCRIPTION OF THE DRAWINGS

FIG. 1A is a pictorial view of a substrate with a bead of nanoparticle paste applied;

FIG. 1B is a second pictorial view of a substrate with a bead of nanoparticle paste application proximate and edge;

FIGS. 2A-2C demonstrate a spin coating application of the nanoparticles to a substrate;

FIG. 2D demonstrates application tools for the nanoparticle paste.

FIGS. 3, 4 and 5 are examples of substrates in which the embodiments disclosed herein may be employed;

FIG. 6 is a side view of a first roller arrangement for RTB processing of a large substrate;

FIG. 7 is a side view of a second roller arrangement for RTB processing of a large substrate;

FIGS. 8A-8E are exemplary roller embodiments;

FIG. 9 is a side view of a pressure cylinder application for use with large substrates;

FIG. 10 is a side view of an air bearing application for use with large substrates;

FIG. 11 is a pictorial view of a flat and beam arrangement for use with large substrates;

FIG. 12 is a partial section pictorial view of vacuum sealed frame arrangement for use with large substrates;

FIG. 13A is a schematic section view of a first embodiment of fixturing for sealing of a vacuum hole in the VIG workpiece;

FIG. 13B is a section view of a second embodiment of fixturing for sealing of a vacuum hole in the VIG workpiece;

FIG. 13C is a section view of a third embodiment of fixturing for sealing of a vacuum hole in the VIG workpiece; and,

FIG. 13D is a section view of a fourth embodiment of fixturing for sealing of a vacuum hole in the VIG workpiece.

### DETAILED DESCRIPTION

The invention described in application of Ser. No. 13/291,956 now U.S. Pat. No. 9,492,990 has been used to successfully create hermetic bonds in many various materials and in substrates ranging from sub-millimeter to 10's of centimeter scales in a process to be referred to herein as room temperature bonding (RTB). This acronym is employed as a generalized description since, while the actual bond line is created at plasma temperatures, those temperatures are highly localized and the remainder of the substrates and surrounding structure/apparatus remain substantially at room temperature. Generally, the entire substrates to be bonded are polished flat, cleaned, aligned, and placed in a bonding fixture which compresses the substrates up against an optical flat for processing. It is also possible to grind and polish the surfaces to sub nanometer finishes and use van der Waal forces to attract the surfaces then bond them together. In either case, it is important that the entire substrate be sufficiently flat with a less than 200 nm Ra surface to insure intimate contact of the surfaces to be bonded during processing. In some cases one substrate has a thin film (can be, but not limited to, an AR, Metal or Low Emissivity coating), of 100's of nanometers applied as an absorbing interlayer at the bond interface, while in others one of the substrates itself absorb energy at the wavelength of the laser used during processing.

The invention disclosed herein provides a method to form the absorbing interlayer for use in the RTB process, as well as a new process and apparatus for bonding larger format substrates such as Vacuum in Glazing/Windows/Fenestration.

The prior art method of forming the energy absorbing layer is to create a thin film, generally via a sputtering or evaporation process. These processes require the entire substrate be placed into a vacuum chamber, which is not convenient for large substrates.

The embodiments disclosed provide a method for bonding of large format substrates by applying a nanoparticle filled paste in a bond line to a first glass substrate of a vacuum in glazing (VIG) pane, said nanoparticle filled paste acting as a heat absorption layer. A second glass substrate of the VIG pane to be bonded to the first glass substrate is then aligned and the first and second substrates are brought into contact at the bond line. A laser beam having a wavelength wherein the first glass substrate is transparent thereto, is directed to penetrate the first substrate and impinge on the heat absorption layer. Energy from the laser beam is absorbed in the heat absorption layer until a plasma is formed and the temperature of the heat absorption layer is raised to a diffusion temperature. The absorption layer is then diffused into the first and second substrates with diffusion bonding of the first and second substrates.

In exemplary embodiments the step of applying a nanoparticle filled paste is accomplished by applying the paste via a spatula, brush, doctor blade, ink jet or regular spray nozzle, or a syringe 24 to spread a thin layer of paste over the surface to be bonded.

In yet other exemplary embodiments applying a nanoparticle filled paste is accomplished by depositing the paste on the first substrate and rotating the substrate resulting in centripetal distribution of the paste.

In an exemplary embodiment, the step of bringing the first and second substrates into contact at the bond line includes etching a gap and separators into the first substrate using a rolled on film mask wherein the separators comprise cylindrical posts or an arrangement of rectangular beams in a grid or mesh pattern.

In yet another of the embodiments, the paste contains particles sized at a diameter equal to the intended gap and the step of bringing the first and second substrates into contact at the bond line results in maintaining separation between the first and second substrates with the particles providing structural support for the substrates to maintain a uniform gap.

In yet another of the embodiments, the step of bringing the first and second substrates into contact at the bond line is accomplished by contacting the first substrate with a single top roller and contacting the second substrate with a single bottom roller. At least one of the top or bottom rollers is transparent to the wavelength of the laser beam. The substrates are then compressed between the top and bottom roller, thereby locally compressing the substrates adjacent the intended bonding location. The laser beam is then directed through the at least one transparent roller.

In various configurations of the embodiments, the rollers are cylindrical to contact the substrates in a line or spherical to contact the substrates in a point.

In yet another embodiment, the step of bringing the first and second substrates into contact at the bond line is accomplished by contacting the first substrate with a pair of top rollers; said top rollers separated to form a gap and contacting the second substrate with a pair of bottom rollers. The laser beam is the directed the laser beam between the top rollers through the gap.

In yet another embodiment, the step of bringing the first and second substrates into contact at the bond line is accomplished by supporting an optical flat and pressure cylinder in a housing, said housing sufficiently large that a work piece formed by the first and second substrates hangs over the edges of the optical flat. The first and second substrates are then clamped at a first location with the pressure cylinder. The steps of directing the laser beam, absorbing energy in the heat absorption layer and diffusing the heat absorption layer are then performed at the first location and upon completion, the cylinder pressure released and the workpiece indexed to a second location to be bonded. The first and second substrates are then clamped at the second location with the pressure cylinder and the steps of directing the laser beam, absorbing energy in the heat absorption layer and diffusing the heat absorption layer performed at the second location, the indexing process repeated to cover the entire workpiece.

In yet another embodiment, the step of bringing the first and second substrates into contact at the bond line is accomplished by clamping the first and second substrates between a floating air-bearing pair, said air-bearing pair applying sufficient pressure to clamp the surfaces but allowing the substrates to slide between the bearing pair without ever touching the work piece. The first and second substrates are then translated between the air bearing pair on an air table.

In one configuration of the embodiment at least one of said pair of air bearings is transparent for transmission of the laser beam.

In an alternative configuration of the embodiment at least one of said pair of air bearings has an opening through which the laser beam is received.

In yet another configuration of the embodiment, at least one of the pair of air bearing is transparent and the laser beam is provided as a duplexed pair to be directed through both of the air bearing pair to a bonding interface.

In yet another configuration of the embodiment, each of the pair of air bearing has an opening and the laser beam is provided as a duplexed pair to be directed through the opening in each of the air bearing pair to a bonding interface.

In yet another embodiment, the step of bringing the first and second substrates into contact at the bond line is accomplished by clamping the first and second substrates between a flat and a pair of beams which extend over a width of the substrates at a periphery to be bonded, the beams having a slot in a longitudinal center line to admit the laser beam to a bond interface.

In yet another embodiment, the step of bringing the first and second substrates into contact at the bond line is accomplished by locating a frame with a first seal around a perimeter of the first substrate and a second seal against a reference flat surface. A vacuum is then applied between the first and second seals through a port to simultaneously evacuate a chamber between the substrates and clamp the frame to the reference flat. The laser beam is then directed at a bond interface adjacent in inner periphery of the frame.

In one configuration of the embodiment, the step of directing the laser beam is accomplished by scanning the laser beam with a 3 axis scanner or a 2 axis scanner and an f-theta lens.

In a second configuration of the embodiment, the step of directing the laser beam is accomplished by moving the stage.

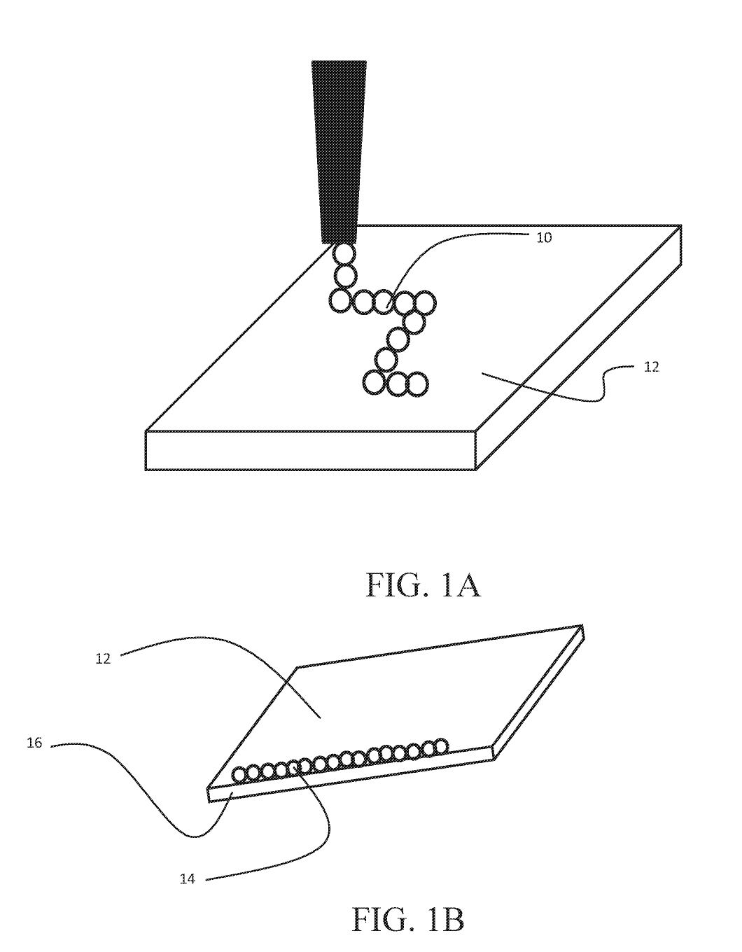

As disclosed herein the energy absorbing layer for RTB is formed by using a nanoparticle filled paste as seen in FIG. 1A wherein a bond line formed of nanoparticle paste 10 is deposited on a substrate 12. For certain applications, a paste bond line 14 may be applied proximate an edge 16 of the substrate 12 as shown in FIG. 1B. In exemplary embodiments, the paste may contain milli/micro/nanoparticles of a metal filler suspended in water or a solvent. Metals like chrome, titanium, silver, gold or dielectrics like silicon nitride may be used (see application of Ser. No. 13/291,956 now U.S. Pat. No. 9,492,990 for more details). The metal nanoparticles can be selected from the set including but not limited to chrome, titanium, silver, gold or dielectrics like silicon nitride. A preferred embodiment uses a paste containing titanium such as: http://www.us-nano.com/inc/sdetail/2610 or http://www.sigmaaldrich.com/catalog/search?term=titanium+paste&interface=All&N=0&mode=match%20partialmax&lang=en&region=US&focus=product or http://shop.solaronix.com/titania-pastes.html.

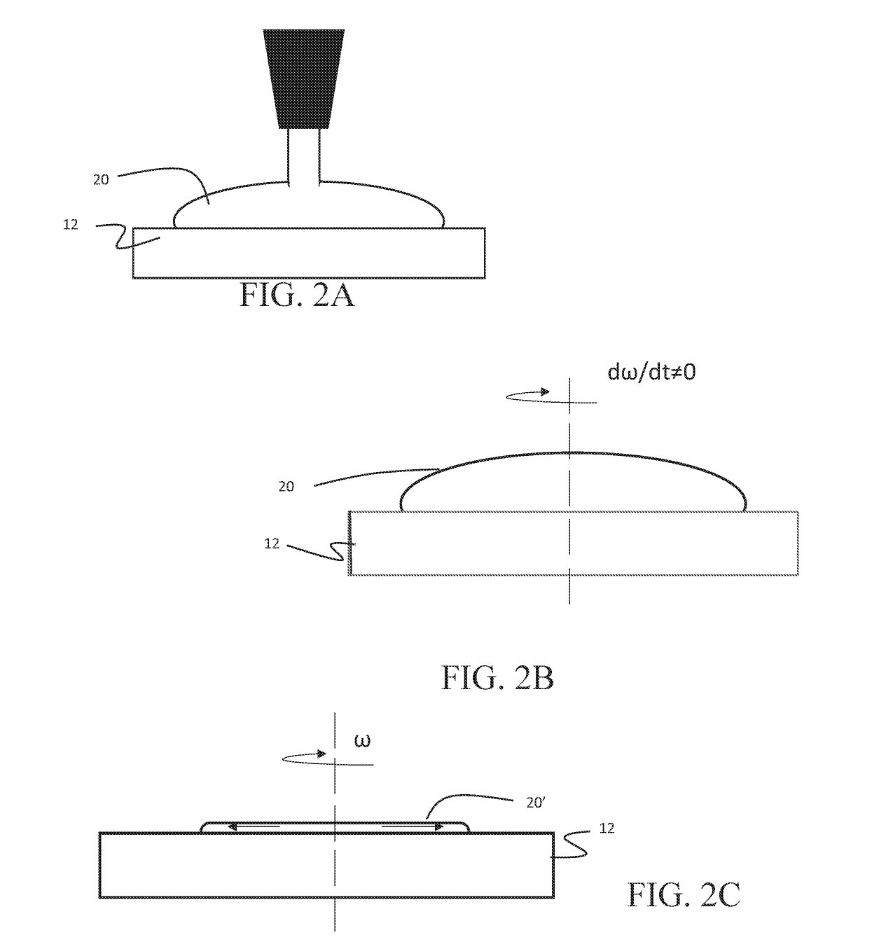

The paste is typically applied to one of the surfaces to be bonded. The paste is patterned on the surface so as to only cover the areas to be bonded. The paste can be applied as seen in FIG. 2D via a spatula 22, brush, doctor blade, ink jet or regular spray nozzle as well as dispensed via a syringe 24 so as to spread a thin layer of paste over the surface to be bonded. Spin coating applied as a process as seen in FIGS. 2A-2C may be employed. The paste 20 is deposited on the substrate 12 as shown in FIG. 2A. The substrate is then rotated as shown in FIG. 2B resulting in centripetal distribution of the paste 20′ as seen in FIG. 2C. The paste may also be applied via a dispenser as a carefully metered bead, and bringing the mating substrates into contact then spreads the bead throughout the interface area.

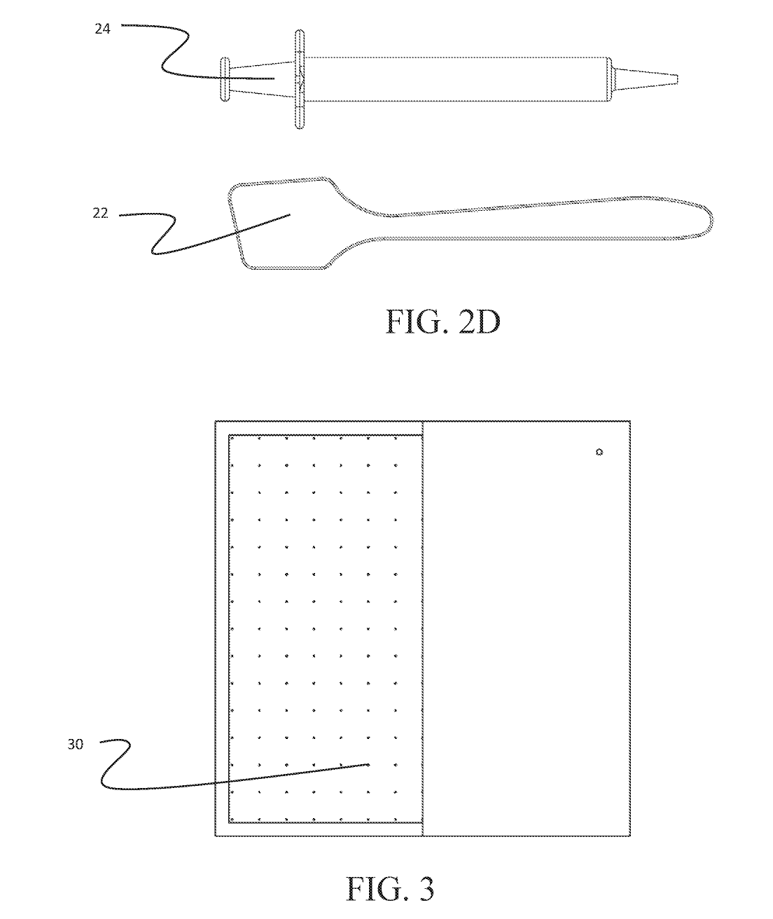

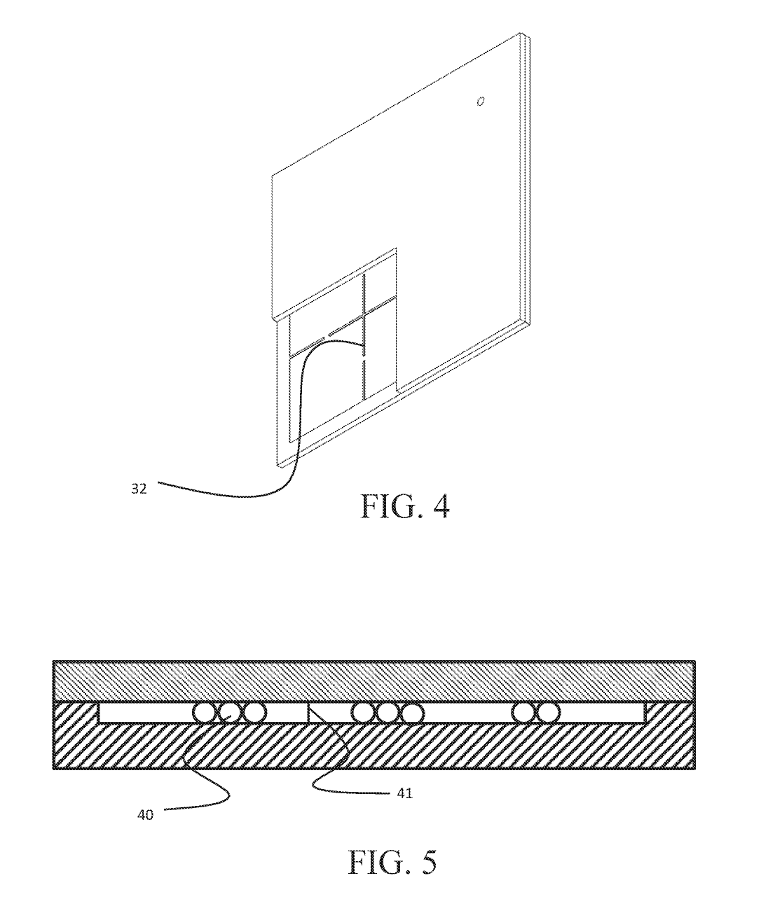

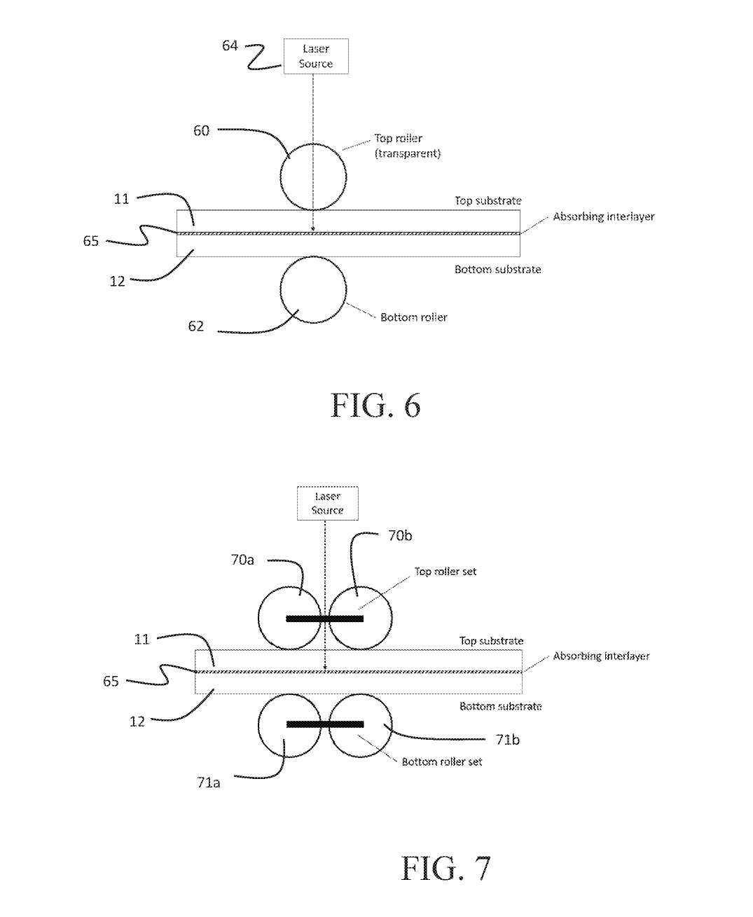

After the paste is applied, the substrates to be bonded are aligned and brought into contact. The paste may in certain embodiments be cured or sintered and diffused into the surface of the glass substrate as described in the RTB patent application (Ser. No. 13/291,956 now U.S. Pat. No. 9,492,990) This process can involve placing pressure on the substrates, for example by placing weights on the top substrate, and placing the mated substrates into an oven for a specified period of time. The purpose of this step is to drive out the liquid base of the paste leaving only a solid thin film energy absorbing layer of nanoparticles. This can also be achieved by strategic laser bonding that pushes the carrier fluid out from between the plates sintering particles in the paste and room temperature bonding the glass plates at the same time. This process is extremely useful for tempered glass because the sintered paste would fill the gaps in between the substrates and compensate for flatness and thickness variation of the tempered glass plates. A gap and separators may be etched into the window, for example on the first glass substrate 12 using a rolled on film mask. The separators can be cylindrical posts 30 as seen in FIG. 3 or an arrangement of rectangular beams 32 as seen in FIG. 4, for example in a grid or mesh pattern. In yet another embodiment, a paste containing milli/micro/nanoparticles 40 that are sized at a similar diameter to the intended gap 41 is used within the chamber as necessary to provide structural support for the substrates and maintain a uniform gap as seen in FIG. 5.

An apparatus for bonding large format substrates is also disclosed herein. In an exemplary prior art process a fixture containing an optical flat and stage which is actuated by pressure cylinders, see FIGS. 3B-3E in US 20130112650 A1. The fixture may also contain features for aligning the substrates. The substrates to be bonded are mated and loaded into the fixture, then pressure cylinders are actuated to further clamp the substrates by pressing them firmly against the optical flat. This fixture is designed to insure intimate contact of the bond joint over the entire substrate, however for large format substrates this method becomes impractical.

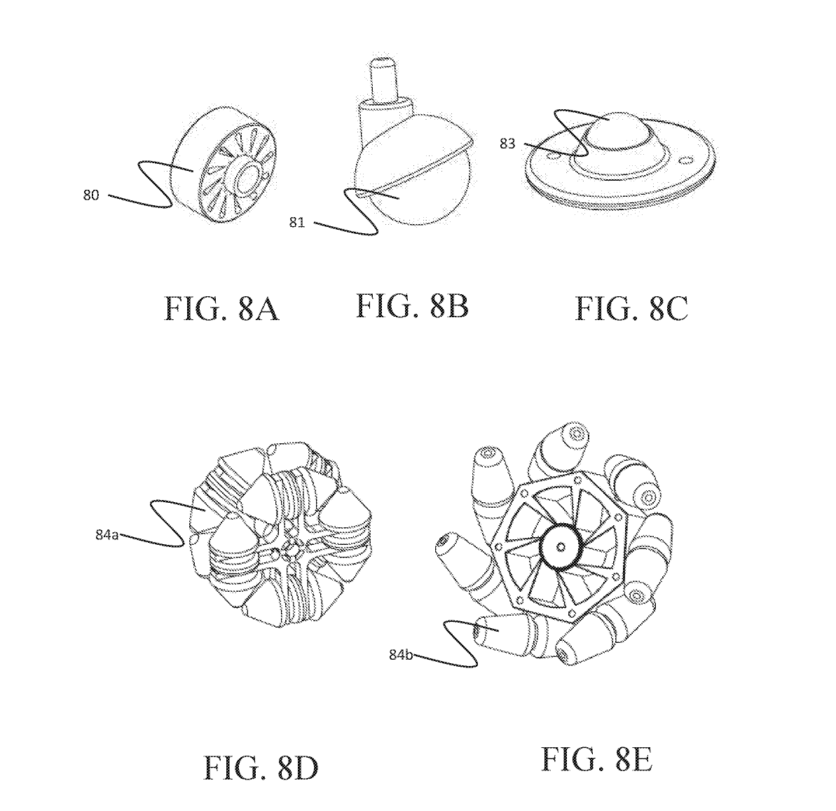

A novel apparatus to bond substrates employs a fixture is shown in FIG. 6 with a single top roller 60 and a single bottom roller 62, at least one of the rollers being transparent to the bonding laser wavelength from a laser source 64. The substrates, 11, 12 to be bonded are compressed between the rolling elements. The rollers are aligned to contact the substrate in a line (cylindrical) or point (spherical), as will be described in greater detail subsequently, thereby locally compressing the substrates to be bonded near the intended bonding location. The laser is directed through at least one roller and focused at the absorbing layer 65 present the interface of the substrates to be bonded. The RTB process employed for bonding of the substrates 10, 12 is accomplished using a laser 64 which has a wavelength such that at least one of the substrates (substrate 11 for the example shown) is transparent to that wavelength. An interface between the layers, the nanoparticle filled paste or low emissivity coating present on the glass, provides a change in the index of transmission or optical transmissivity which results in absorption of laser energy at the interface and localized heating to create a bond. In a first embodiment, a heat absorption layer 65, which is opaque or blocking to the laser wavelength and has an affinity for diffusion into the substrates, is deposited on the mating surface of at least one of the substrates (substrate 12 for the example shown) as previously described. The heat absorption layer in example embodiments for glass-to-glass herein may be a metal, semiconductor or ceramic material. However, in alternative embodiments other materials having appropriate wavelength absorption and diffusion affinity characteristics may be employed. The thickness of the heat absorption layer may be as thin as 10 Å and as thick as desired to compensate for surface roughness or control timing and temperatures of the process. The heat absorption layer may be continuous, segmented strips or dots, as previously described.

The laser energy penetrates the first substrate 11 and impinges on the heat absorption layer, 65. The heat absorption layer will continue to absorb the energy until a plasma is formed and the temperature of the heat absorption layer is raised to a diffusion temperature. The absorption layer then diffuses into the substrates. However, before the absorption layer diffuses, the glass surfaces in near proximity to the surface to the heart absorption layer soften until the heat absorption layer diffuses into the glass. However, the substrate surfaces are not melted. Upon diffusion into the glass, the material from the heat absorption layer becomes transparent to the laser energy. Once the heat absorption layer diffuses the plasma collapses and the glass substrates are fused together into a permanent bonded joint. It is important to note that the heat absorption layer should diffuse at temperature that is higher than the first transition temperature of the glass (but less than melting temperature) to ensure that the glass becomes soft and bonds to the neighboring glass. This approach makes the most robust, least particulate sensitive bond joint.

For a nanoparticle filed paste, bonding is accomplished on the inner portion of the paste line first to push the evaporating liquid out of the joint from the inside out to prevent outgassing into space between panes of the window. A proper cleaning of the glass before assembling and bonding is necessary. The reason for the cleaning step is to avoid the presence of carbon molecules that can be photo-fragmented by UV irradiation and raise the pressure in the chamber after it had been evacuated. The best cleaning processes to eliminate such contaminations are: solvent clean (acetone, methanol, IPA), Piranha clean, RCA clean.

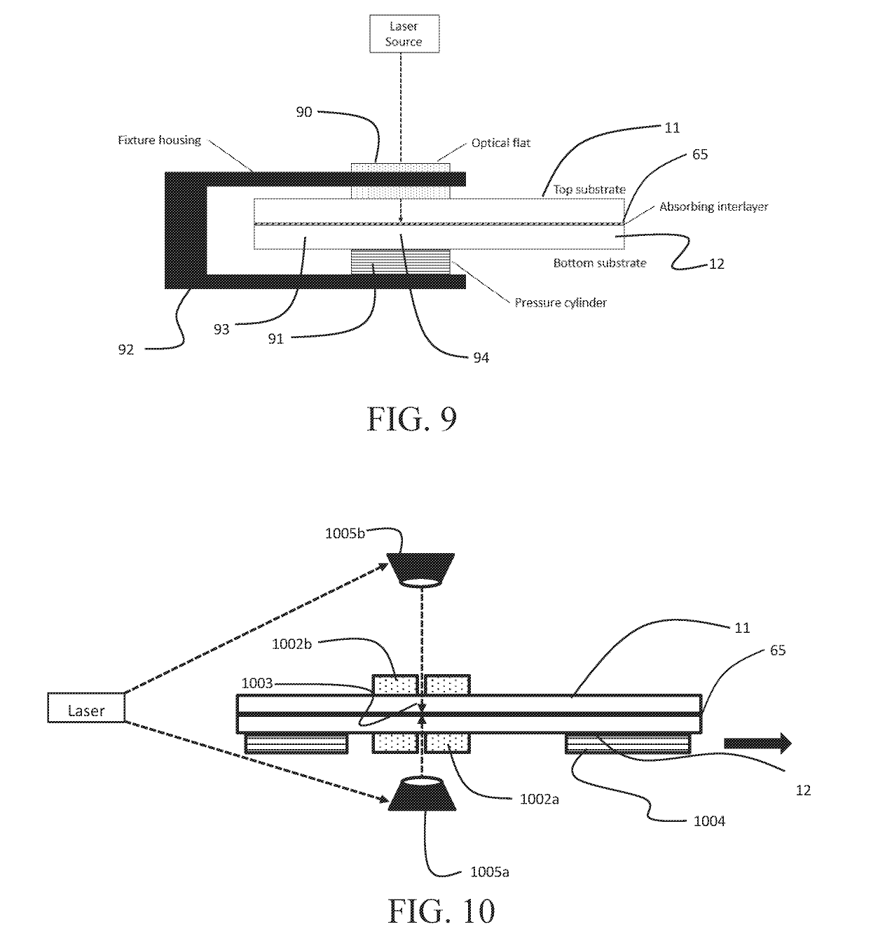

In another embodiment of the apparatus, multiple rollers 70a, 70b and 71a, 71b are used in roller sets, such that the rollers create a localized contact patch. AT least the top rollers 70a, 70b are separated to form a gap and the laser can be directed between the rollers through the gap as seen in FIG. 7. In this case, none of the rollers need be transparent.

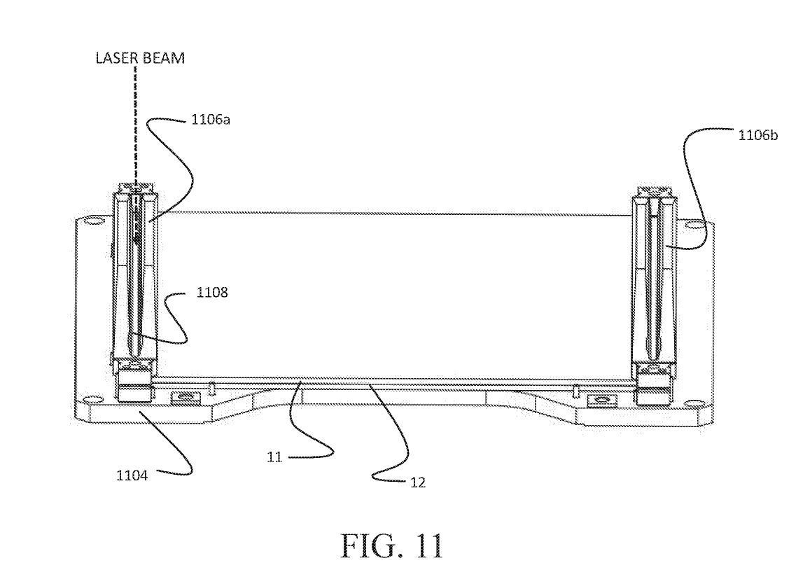

FIGS. 8A-8E show examples of roller types that can be incorporated into the apparatus including cylindrical rollers 80, spherical rollers 81, spherical wheels 82, ball transfer units 83, multi directional rollers (Mecanum wheel systems) 84a, 84b.

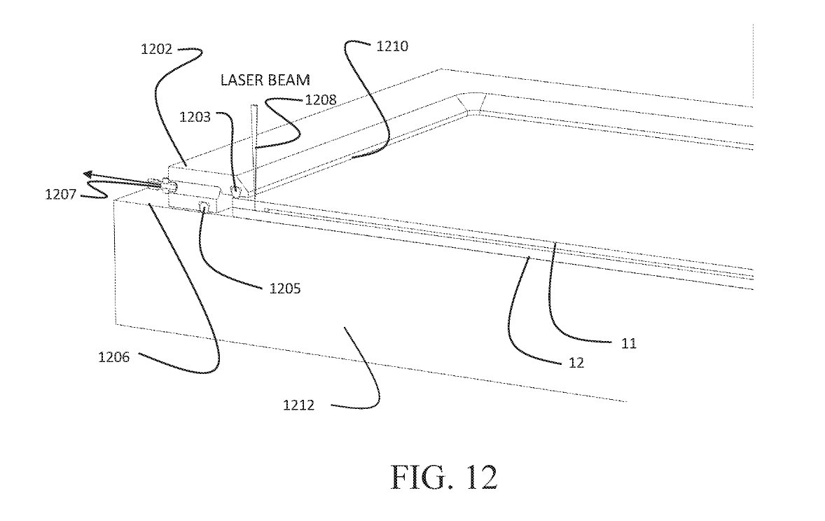

In yet another embodiment of the apparatus seen in FIG. 9, an optical flat 90 and pressure cylinder 91 supported in a housing 92 are used, similar to application of Ser. No. 15/275,187 except that the fixture housing is sufficiently large that the work-piece can hang over the edges of a smaller optical flat. For this embodiment the pressure cylinder locally clamps the substrates 11, 12 forming the work-piece to be bonded, at a first location 93 and once bonding is completed at the first location, the cylinder pressure is released and the work-piece is indexed to a second location 94 to be bonded, then the cylinder pressure is applied to clamp the first and second substrates at the second location for bonding. The indexing process can continue to cover the entire work-piece.

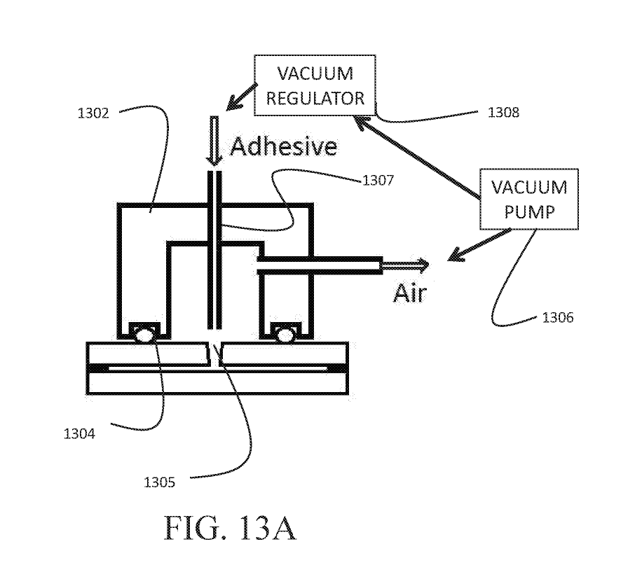

In yet another embodiment of the apparatus shown in FIG. 10, the substrates 11, 12 are clamped between a floating air-bearing pair 1002a, 1002b that applies enough pressure to clamp the surfaces but lets the substrates slide between the bearing pair without ever touching the work piece. The air bearing can either be transparent, or may have an opening 1003 for the laser 1005a, 1005b duplexed pair for the embodiment shown) to be directed through to the bonding interface. The substrates translate between the air bearing and ride on an air table 1004, while the bearing surfaces keep sufficient pressure to insure the substrates are in intimate contact during the bonding process.

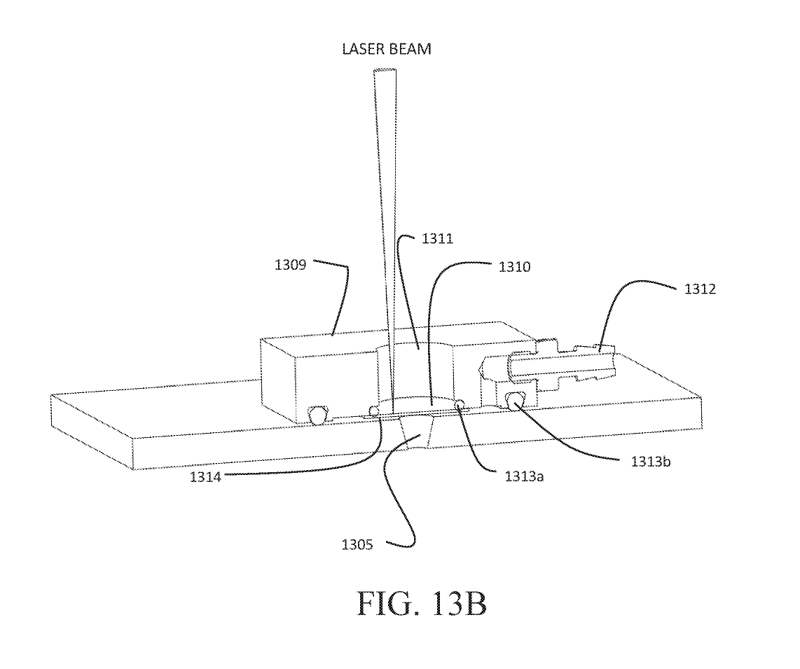

In yet another embodiment of the apparatus shown in FIG. 11, the substrates 10,11 are clamped between two metal structural elements such as a flat 1104 and a pair of beams 1106a and 1106b which extend over the width of the substrates at a periphery to be bonded and are screwed to the flat at either end. The metal structural elements will have a slot 1108 in a longitudinal center line so that the laser light can go through and be focused at the bond interface. The slot can be on both clamping parts (beam and flat) or just on one side depending if the substrates will be bonded from both sides or one side only.

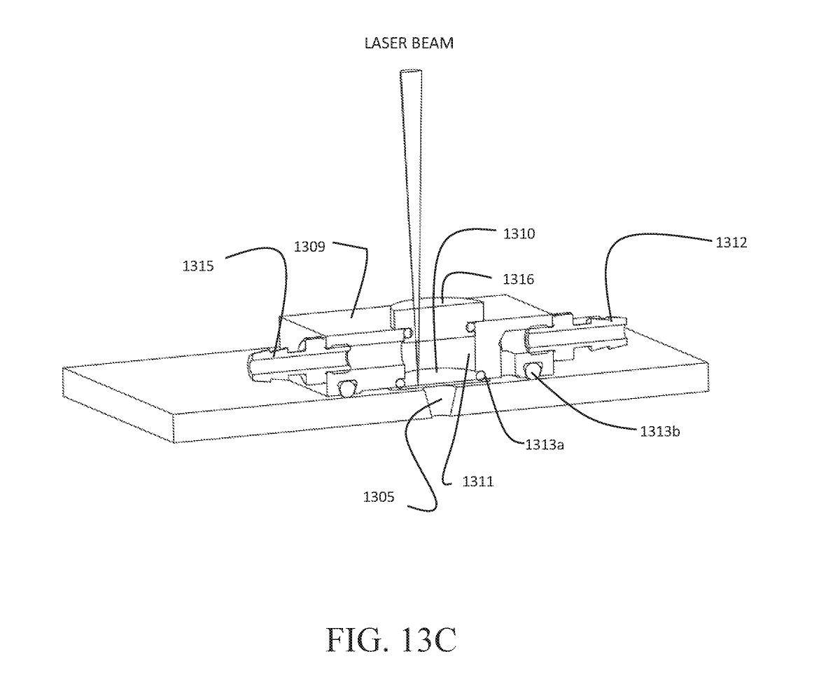

In yet another embodiment of the apparatus seen in FIG. 12, a frame 1202 is located with a seal 1203 around the perimeter of an upper substrate 10 and another seal 1205 is formed against a reference flat surface 1206 on a stage 1212. The seals may be o-rings or similar structures. Applying vacuum between the seals through a port 1207 simultaneously evacuates the chamber between the substrates 1204a and 1204b and clamps the assembly to the reference flat for room temperature laser bonding. Rather than applying a vacuum, the bonding process may be performed by evacuating or purging the air between the substrates and introducing a specific gas, such as Argon, within the assembly prior to bonding. In alternative embodiments the frame may comprise a flexible structure such as elastomer, mastic, or a combination thereof.

After clamping, the substrates will be bonded by aiming the laser 1208 at a bond interface adjacent an inner periphery 1210 of the frame and scanning the beam with a 3 axis scanner, a 2 axis scanner and an f-theta lens or by moving the stage 1212 or a combination of scanning and stage movement.

For any of the embodiments described in FIGS. 6-12, another aspect of the invention is to apply the laser beam from both sides of the mated substrates to both sinter the paste and RTB the glazing/glass substrates at the same time. Sintering and RTB may be done from one side if the gap is small enough, for example less than 100 um. However, if the gap is too large, then operation from both sides may be required for the sintering. If the gap is even larger yet, then sintering may have to be completed in an oven. However, the parts in contact will be RTB, where the gaps will be filled with sintered material. This aspect is very important because it allows the use of milli/micro/nanoparticle filled paste as an absorbing interlayer so sintering and room temperature bonding the glass plates can occur at the same time directly with the laser beam, avoiding the need of heating the glazing in an oven to sinter the paste. This process is extremely useful for tempered glass because the sintered paste would fill the gaps in between the substrates and compensate for flatness and thickness variation of the tempered glass plates.

Another aspect of the invention as disclosed herein is methods to evacuate the chamber of the VIG by drawing a vacuum, and capping and sealing the vacuum hole in the glazing. The vacuum may be drawn by making a small hole (laser-machining for example) in one of the substrates. After the substrates are sealed around a peripheral edge, a vacuum is drawn. The hole may then be sealed in many different ways.

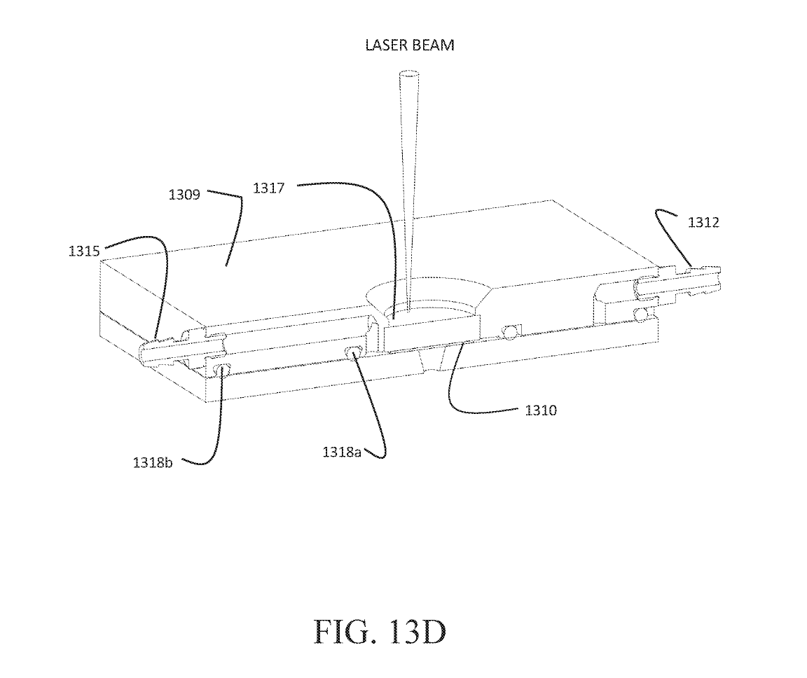

One embodiment of the apparatus seen in FIG. 13A uses a fixture 1302 with an O-ring 1304 surrounding a vacuum hole 1305. The fixture has two connections: one to a vacuum pump 1306 and the second one to a syringe 1307 loaded with adhesive. The syringe itself is also connected to a vacuum pump through a vacuum regulator 1308. Vacuum is applied with the regulator fully open (to prevent the adhesive from being drawn into the VIG) and vacuum starts to be drawn in the chamber. When the desired level of vacuum is reached, the regulator can be partially closed and the glue will start to flow into the hole to seal it. The glue can be cured by UV light and become a plug when fully cured. The hole can be conically shaped so that the plug of cured adhesive is wedged into the hole by the internal vacuum in a self-wedging “keystone” fashion, reducing the exposure of the glue/glass bond to shear forces.

As an alternative to using glue to plug the hole in the VIG, a small sheet of glass may be RTB (room temperature bonded) over the hole. This offers better hermeticity of the VIG. Using adhesive for the primary plugging simplifies the fixturing necessary for RTB to clamping only, since evacuation is taken care of during adhesive application.

As seen in FIG. 13B, a fixture 1309 designed to room temperature bond a small patch of glass 1310 on top of the vacuum hole 1305. The fixture has an opening 1311 through which the laser beam can pass and be focused at the interface between the surface 1314 of the VIG and the patch of glass for Room Temperature Bonding. The fixture is connected to a vacuum pump through a port 1312 and it is sealed on the surface of the VIG and the glass cap through two O-rings 1313a, 1313b. Drawing vacuum on the port holds the tool in place on the VIG, clamps the patch glass in contact with the VIG, and evacuates the VIG through the unsealed interface between the cap and the VIG. Laser bonding through the center aperture can be performed when the desired vacuum is reached sealing the interface between the cap and VIG.

To speed up the evacuation time, a slightly different apparatus can be employed as shown in FIG. 13C. Differential vacuum between the port 1312 and a second port 1315 in fixture 1309 allows the glass patch 1310 to be drawn upward to a small O-ring 1313a. A plug 1316 is employed to close laser opening 1311. Screws (not shown) or the resilience of o-ring 1313b raise the tool and the patch slightly off of the VIG surface, while the large O-ring 1313b maintains the evacuation seal. This gap between the patch and the panel allows better flow during evacuation. After evacuation of the VIG, the tool is lowered by adjusting the screws (not shown) or reducing vacuum in port 1315 until the patch contacts the VIG, plug 1316 is removed, and laser bonding takes place through the opening 1311. Alternatively, the patch can be clamped to the tool using clips or magnets.

Yet another embodiment of the apparatus seen in FIG. 13D incorporates a window 1317 that is transparent to the bonding laser mounted by an airtight means (adhesive, O-ring) into fixture 1309 in place of the plug 1316. The transparent window is used to clamp the glass cap to the VIG. The fixture seals to the VIG surface using two O-rings 1318a, 1318b. The VIG is evacuated by applying vacuum to the area inside the inner O-ring 1318a using port 1312. This vacuum also serves to lightly hold the fixture in place on the VIG. The distance of the fixture from the VIG and, if they are in contact, the clamping force applied to the cap by the window, may be adjusted by varying the pressure between the two O-rings by applying vacuum on port 1315. Decreasing the pressure draws the fixture toward the VIG, while increasing the pressure pushes the tool away from the VIG surface (still sealed by O-rings). This allows the glass cap to slide sideways under the tool, or drop by gravity away from the VIG and onto the window, when it is desired to expose the evacuation hole. When vacuum is applied between the O-rings on port 1315, the fixture pulls against the cap, clamping it against the VIG for RTB. Reference features may be used inside the fixture to help properly locate the glass cap for clamping and bonding.

Having now described various embodiments of the disclosure in detail as required by the patent statutes, those skilled in the art will recognize modifications and substitutions to the specific embodiments disclosed herein. Such modifications are within the scope and intent of the following claims

What is claimed is:

1. A method for bonding of large format substrates comprising:
applying a nanoparticle filled paste in a bond line to a first glass substrate of a vacuum in glazing (VIG) pane, said nanoparticle filled paste acting as a heat absorption layer;
aligning a second glass substrate of the VIG pane to be bonded to the first glass substrate;
bringing the first and second substrates into contact at the bond line;
directing a laser beam having a wavelength wherein the first glass substrate is transparent thereto, to penetrate the first substrate and impinge on the heat absorption layer;
absorbing energy from the laser beam in the heat absorption layer until a plasma is formed and the temperature of the heat absorption layer is raised to a diffusion temperature; and,
diffusing the absorption layer into the first and second substrates with diffusion bonding of the first and second substrates.

2. The method as defined in claim 1 wherein the step of applying a nanoparticle filled paste comprises: applying the paste via a spatula, brush, doctor blade, ink jet or regular spray nozzle, or a syringe 24 to spread a thin layer of paste over the surface to be bonded.

3. The method as defined in claim 1 wherein the step of applying a nanoparticle filled paste comprises:
depositing the paste on the first substrate; and
rotating the substrate resulting in centripetal distribution of the paste.

4. The method as defined in claim 1 wherein the step of bringing the first and second substrates into contact at the bond line comprises: etching a gap and separators into the first substrate using a rolled on film mask, said separators comprising cylindrical posts or an arrangement of rectangular beams in a grid or mesh pattern.

5. The method as defined in claim 1 wherein the paste contains particles sized at a diameter equal to the intended gap and the step of bringing the first and second substrates into contact at the bond line comprises maintaining separation between the first and second substrates with the particles providing structural support for the substrates to maintain a uniform gap.

6. The method as defined in claim 1 wherein the step of bringing the first and second substrates into contact at the bond line comprises:
contacting the first substrate with a single top roller;
contacting the second substrate with a single bottom roller, at least one of the top or bottom rollers being transparent to the wavelength of the laser beam;
compressing the substrates between the top and bottom roller, thereby locally compressing the substrates adjacent the intended bonding location;
and the step of directing the laser beam includes directing the laser beam through the at least one roller.

7. The method as defined in claim 6 wherein the rollers are cylindrical to contact the substrates in a line or spherical to contact the substrates in a point.

8. The method as defined in claim 1 wherein the step of bringing the first and second substrates into contact at the bond line comprises:
contacting the first substrate with a pair of top rollers; said top rollers separated to form a gap;
contacting the second substrate with a pair of bottom rollers; and the step of directing the laser beam includes directing the laser beam between the top rollers through the gap.

9. The method as defined in claim 1 wherein the step of bringing the first and second substrates into contact at the bond line comprises:
supporting an optical flat and pressure cylinder in a housing, said housing sufficiently large that a work piece formed by the first and second substrates hangs over the edges of the optical flat;
clamping the first and second substrates at a first location with the pressure cylinder;
said steps of directing the laser beam, absorbing energy in the heat absorption layer and diffusing the heat absorption layer performed at the first location and upon completion, releasing the cylinder pressure and indexing the workpiece to a second location to be bonded;
clamping the first and second substrates at the second location with the pressure cylinder;
said steps of directing the laser beam, absorbing energy in the heat absorption layer and diffusing the heat absorption layer performed at the second location, the indexing process repeated to cover the entire workpiece.

10. The method of claim 1 wherein the step of bringing the first and second substrates into contact at the bond line comprises:
clamping the first and second substrates between a floating air-bearing pair, said air-bearing pair applying sufficient pressure to clamp the surfaces but allowing the substrates to slide between the bearing pair without ever touching the work piece; and,
translating the first and second substrates between the air bearing pair on an air table.

11. The method as defined in claim 10 wherein at least one of said pair of air bearings is transparent for transmission of the laser beam.

12. The method as defined in claim 10 wherein at least one of said pair of air bearings has an opening through which the laser beam is received.

13. The method as defined in claim 11 wherein each of said pair of air bearing is transparent and the laser beam is provided as a duplexed pair to be directed through both of the air bearing pair to a bonding interface.

14. The method as defined in claim 12 wherein each of said pair of air bearing has an opening and the laser beam is provided as a duplexed pair to be directed through the opening in each of the air bearing pair to a bonding interface.

15. The method as defined in claim 1 wherein the step of bringing the first and second substrates into contact at the bond line comprises:
clamping the first and second substrates between a flat and a pair of beams which extend over a width of the substrates at a periphery to be bonded, said beams having a slot in a longitudinal center line to admit the laser beam to a bond interface.

16. The method as defined in claim 1 wherein the step of bringing the first and second substrates into contact at the bond line comprises:
locating a frame with a first seal around a perimeter of the first substrate and a second seal against a reference flat surface;
applying vacuum between the first and second seals through a port to simultaneously evacuate a chamber between the substrates and clamp the frame to the reference flat;
and the step of directing the laser beam comprises directing the laser beam at a bond interface adjacent in inner periphery of the frame.

17. The method as defined in claim 16 wherein the step of directing the laser beam further comprises scanning the laser beam with a 3 axis scanner or a 2 axis scanner and an f-theta lens.

18. The method as defined in claim 16 wherein the step of directing the laser beam further comprises scanning the laser beam by moving the stage.

19. The method as defined in claim 16 wherein the seals are o-rings.

20. The method as defined in claim 16 wherein the frame comprises a flexible structure such as elastomer, mastic, or a combination thereof.
